(19) United States
(12) Patent Application Publication
(10) Pub. No.: US 2012/0287466 A1
(43) Pub. Date: Nov. 15, 2012

(54) IMAGE PROCESSING APPARATUS

(76) Inventors: Kenji ITOH, Osaka (JP); Naoya Arifuku, Osaka (JP)

(21) Appl. No.: 13/460,946

(22) Filed: May 1, 2012

(30) Foreign Application Priority Data
May 12, 2011 (JP) 2011-107225

(51) Int. Cl. G06K 15/02

(52) U.S. Cl. 358/1.15

(57) ABSTRACT

Provided is an image processing apparatus enabling to equip a removable functional component providing a predetermined function, in which, when a functional component is newly mounted, it is allowed to make sure to perform adjustment required for the functional component. The image processing apparatus, which is able to equip a removable functional component providing a predetermined function, includes a touch panel as an operation panel. When the image processing apparatus is started in a state where the functional component is newly mounted, the image processing apparatus displays a transition button (adjustment button) for transferring to an adjustment screen for performing adjustment concerning the above-described functional component, and displays the above-described adjustment screen when the adjustment button is pressed.

### CROSS-NOTING PARAGRAPH

This non-provisional application claims priority under 35 U.S.C. §119 (a) on Patent Application No. 2011-107225 filed in JAPAN on May 12, 2011, the entire contents of which are hereby incorporated herein by reference.

### FIELD OF THE INVENTION

The present invention relates to an image processing apparatus which is able to equip a removable functional component providing a predetermined function.

### BACKGROUND OF THE INVENTION

Conventionally, some of image processing apparatuses such as image forming apparatuses and the like equip a removable functional component providing a predetermined function. When equipping the functional component, it is necessary to set up the apparatus according to the component.

For example, a printer described in Japanese Laid-Open Patent Publication No. 2004-276454 is configured to judge whether or not initial setting processing is completed in the case of being powered on in a state where a new optional device or the like is mounted, then select a setup mode in the case of not being completed, and select a normal print mode in the case of being completed. Further, such the setup mode is configured to specify an identifier of the printer associated with a configuration of the detected optional device in a state of being mounted to transmit the specified identifier to a host, thereby guiding a user to the setup.

In Japanese Laid-Open Patent Publication No. 2004-276454, in order to display and guide setup processing in the case of combining options, it is impossible to use a function different from the options. For example, in the case of connecting an option of a post-processing system, it is possible to use a scanner function and a FAX transmitting function using a reading system, thus needing to allow use of an appropriate function even when setting of the option is not performed. Therefore, in the case of using a plurality of options in combination, it is configured that an installation operator moves to an information input screen of the option according to a procedure to input various information so as to be able to use an optional function.

In Japanese Laid-Open Patent Publication No. 2005-227561, a technique is disclosed for promptly performing update of a control program of an image forming apparatus body at low cost. The image forming apparatus described in Japanese Laid-Open Patent Publication No. 2005-227561 includes reading means for reading an update program that is stored in a nonvolatile memory; judging means for judging whether or not to update a control program that is stored in the image forming apparatus body to the update program read by the reading means; means for displaying a message on an operation panel in the case of judging to update; and rewriting means for updating the control program to the update program when a user selects update according to the message on the operation panel.

However, according to the technique described in Japanese Laid-Open Patent Publication No. 2004-276454, a service technician such as an installation operator performs work for operation on an information input screen of the option, thus being configured to force to perform complicated operation, thereafter allowing to move so that a common user is not able to move to the information input screen, which leads to a complicated procedure and making mistakes such as skipping operation in some cases.

Further, the technique described in Japanese Laid-Open Patent Publication No. 2005-227561 is provided only for displaying on an operation panel a message whether or not to update and such guiding only allows the control program to be updated to an update program, thus being impossible to address a case where an additional functional component is needed to be adjusted, then also having a possibility that a situation where the adjustment is forgotten is caused.

### SUMMARY OF THE INVENTION

An object of the present invention is to make it possible to surely conduct a necessary adjustment for a functional component when the functional component is newly installed in an image processing apparatus which is able to equip a removable functional component providing a predetermined function.

An object of the present invention is to provide an image processing apparatus which is able to equip a removable functional component providing a predetermined function and is provided with a touch panel as an operation panel, wherein when the image processing apparatus is started in a state where the functional component is newly mounted, a transition button is displayed on a start screen displayed on the operation panel for transferring to an adjustment screen for performing adjustment concerning the functional component, and when the transition button is pressed, the adjustment screen is displayed.

Another object of the present invention is to provide the image processing apparatus, wherein the transition button is displayed until an adjustment item required for activating the functional component is set.

Another object of the present invention is to provide the image processing apparatus, wherein on the adjustment screen, only a list of adjustment items required for activating the functional component among adjustment items concerning the functional component is displayed.

Another object of the present invention is to provide the image processing apparatus, wherein the adjustment screen is configured to be displayable even in an operation procedure in which the transition button is not pressed from the start screen.

### BRIEF DESCRIPTION OF THE DRAWINGS

FIG. 1 is a functional block diagram showing a configuration example of an image processing apparatus according to the present invention;

FIG. 2 is a diagram showing an example of a start screen in the image processing apparatus of FIG. 1;

FIG. 3 is a diagram showing an example of an adjustment screen in the image processing apparatus of FIG. 1;

FIG. 4 is a diagram showing another example of the adjustment screen in the image processing apparatus of FIG. 1; and

FIG. 5 is a flowchart for explaining an example of processing at the time of starting in the image processing apparatus of FIG. 1.

### PREFERRED EMBODIMENTS OF THE INVENTION

An image processing apparatus according to the present invention is an apparatus such as a multi-functional peripheral, an image forming apparatus or a scanner apparatus which is able to equip a removable functional component providing a predetermined function and is provided with a touch panel as an operation panel. The removable functional components for the multi-functional peripheral include a finisher, an automatic document feeder (ADF), an additional paper feeding tray, a fax device and the like. Moreover, the removable functional components for an image forming apparatus such as a printer include an additional paper feeding tray and the like. The removable functional components for the scanner apparatus include the ADF and the like. Hereinafter, description will be given assuming that the image processing apparatus according to the present invention is the multi-functional peripheral, however, even another type of the image processing apparatus is similarly applicable.

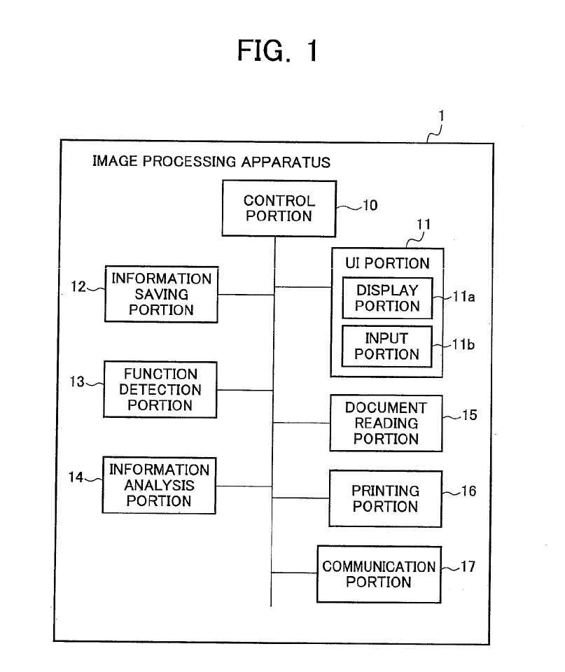

FIG. 1 is a functional block diagram showing a configuration example of an image processing apparatus according to the present invention.

An image processing apparatus 1 illustrated in FIG. 1 is comprised of a control portion 10, a user interface (UI) portion 11, an information saving portion 12, a function detection portion 13, an information analysis portion 14, a document reading portion 15, a printing portion 16 and a communication portion 17, which are connected to one another.

The control portion 10 is able to be illustrated as a module including a CPU (Central Processing Unit), and storage devices such as a RAM (Random Access Memory) as a work area, a ROM (Read Only Memory) as a storage area of a control program and an EEPROM (Electrically Erasable Programmable ROM). Such a control program is distributed via a transportable recording medium or distributed via a network such as the Internet, and stored in the above-described storage device in a state of being executable from the CPU, thereby being able to be implemented.

This makes it possible for the control portion 10 to perform control of various functions in the image processing apparatus 1. For example, the control portion 10 controls not-shown various mechanism systems in the image processing apparatus 1, performs data transfer of image data from the document reading portion 15 to the information analysis portion 14, transfers the converted image data from the information analysis portion 14 to the printing portion 16 or the communication portion 17, and controls the UI portion 11 to display output information to a user and set input information from the user.

The UI portion 11 is a touch panel as an operation panel, and provided with a display portion 11a comprised of a display panel made of liquid crystal, organic EL or the like and a display control circuit thereof, and an input portion 11b comprised of a touch sensor, while storing a UI program for providing a user with a UI including a software button so as to be executable. The touch sensor may be provided separately from the display panel, however, may be embedded in each pixel of the display panel. In this manner, the UI portion 11 is comprised of a display medium made of liquid crystal or the like and an input medium such as a touch sensor and a software button. Additionally, the UI program itself may be included in the above-described control program. The UI portion 11 with such a configuration displays data of a content desired to be displayed according to control by the control portion 10, and transmits input information from the touch sensor to the control portion 10 for setting.

The information saving portion 12 is a module comprised of a hard disk for temporarily saving or permanently saving read image data, a memory such as an EEPROM for holding various setting information and the like. The document reading portion 15 is a module mounting an optical system such as a scanner capable of optically reading a document to obtain image data for outputting the image data so as to be temporarily saved or permanently saved in the information saving portion 12. The printing portion 16 is a printer or the like for printing on a specified sheet image data saved in the information saving portion 12 and converted for print. The communication portion 17 is a module such as a scanner or a fax for performing data transmission of read data or saved data as defined image data for the outside. Further, the communication portion 17 is able to temporarily save or permanently save the image data received by fax in the information saving portion 12 to be printed at the printing portion 16.

The function detection portion 13 is a module for judging that an optional functional component is newly mounted. For example, in a case where an external tray is newly mounted, it needs to move to an adjustment screen to perform positioning of the tray. In a case where a finisher is newly mounted, it needs to move to the adjustment screen to perform positioning of the finisher. In a case where an image processing option is newly mounted, it needs to move to the adjustment screen to perform color setting of image processing. Therefore, it needs to first detect that a functional component is newly mounted (added), and the image processing apparatus 1 is thus provided with the function detection portion 13.

The information analysis portion 14 is a module for performing image processing for converting read image data or saved image data into an image corresponding to various functions, checking processing for checking component information of a serial number, a model number and the like that are transmitted from various options, and the like.

Then, the control portion 10 detects a newly mounted functional component at the function detection portion 13 at the time of starting, or the like, thereby judging whether or not the image processing apparatus 1 is started in a state where the functional component is newly mounted. When the image processing apparatus 1 is started in the state where the functional component is newly mounted, that is, when at least one or more new functions are added, the control portion 10 displays a transition button as follows on a start screen displayed at the display portion 11a of the UI portion 11. The start screen refers to an initial screen to be presented so as to be operable by a user at the time of starting. The transition button is a button for transferring to the adjustment screen for performing adjustment concerning the above-described functional component.

The UI portion 11 awaits pressing of the transition button in a state where the transition button is displayed, and displays the adjustment screen in the case of being pressed. The UI portion 11 accepts input of information related to adjustment while displaying the adjustment screen, thereby enabling adjustment of at least an added new function.

Conventionally, a special screen such as the adjustment screen is configured to allow moving only by special input operation so that a common user or the like is not able to use in order to enhance confidentiality by not allowing a set value to be easily changed. However, in the case of newly adding an option or the like, it surely needs to move to the special screen to input various setting and confirm a connection status. Whereas, in the image processing apparatus 1 according to the present invention, in the case of being started by adding an optional functional component (for example, finisher), the transition button (link icon) to the adjustment screen of the functional component is displayed on the start screen, so that it is possible to perform setting promptly. Moreover, it is possible to move to the adjustment screen without performing complicated input, thus allowing simplification of amounting procedure of an option.

In this manner, in the image processing apparatus 1 according to the present invention, in the case of adding a new function, the transition button capable of transferring to the adjustment screen (adjustment screen for an item to be manually adjusted) is arranged on the start screen so that it is possible to easily transfer to the adjustment screen. Additionally, in the image processing apparatus 1 according to the present invention, the transition button is displayed on the start screen, thus attracting an operator's attention at the time of confirming start-up so as to make sure to perform adjustment. In this manner, according to the present invention, occurrence of mistakes in which adjustment work is not performed is suppressed and it is possible to easily move to the adjustment screen, thus enabling simplification of a procedure, and also shortening the time to mount.

In the above explanation, description has been given assuming the case of being started in a state where one functional component is newly mounted, however, it is applicable even for the case of being started in a state where a plurality of functional components are mounted at the same time. In a case where a plurality of functional components are newly mounted, a different transition button for each of the functional components may be displayed at the same time to be transferred to each adjustment screen, or a common transition button for apart or all of functional components newly mounted may be displayed to be transferred to a common adjustment screen for the part or the all of functional components newly mounted.

Further, in the case of adjustment in a restricted order, such an order may be stored in a memory in advance to read the order before displaying the transition button, and display the transition button for the functional component required for first adjustment. Thereafter, when the adjustment is finished, the transition button for the functional component required for next adjustment may be displayed. In this manner, in the case of the restricted order, the transition button may be displayed in a display order corresponding to the order. In the case of no restricted order for a part of functional components among a plurality of functional components newly mounted, the transition button to the adjustment screen may be displayed so as to collectively adjust at the beginning, or the transition button to the adjustment screen may be displayed so as to collectively adjust at the end.

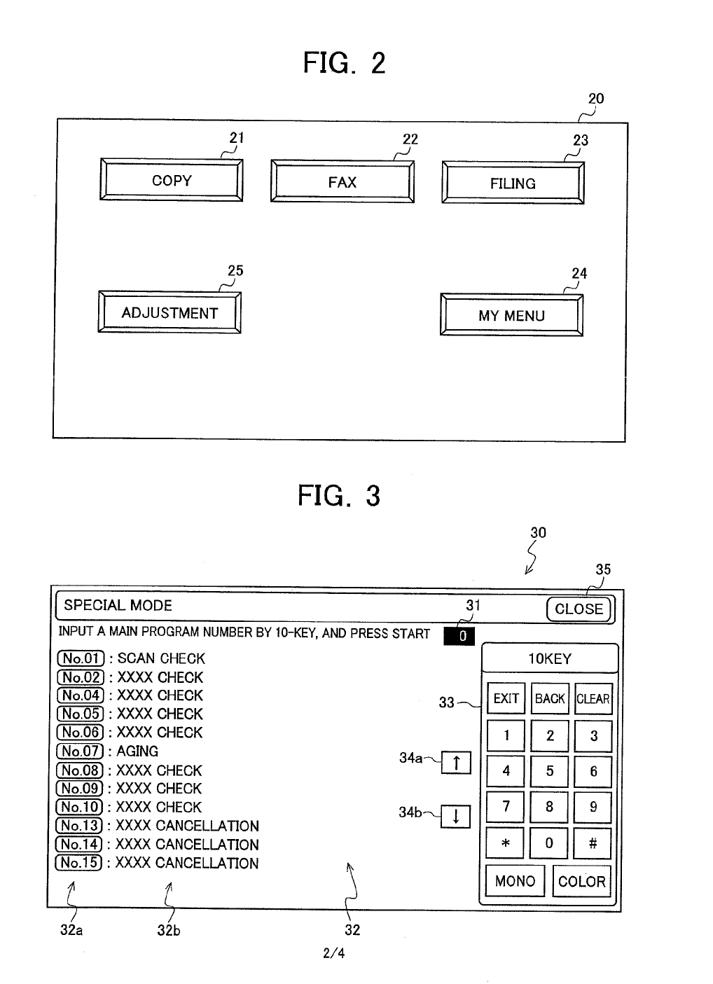

Next, with reference to FIG. 2, description will be given for an example of a start screen in the image processing apparatus of FIG. 1. A start screen 20 illustrated in FIG. 2 displays a copy button 21 for transferring to a basic screen of a copy function, a fax button 22 for transferring to a basic screen of a fax function, a filing button 23 for transferring to a basic screen of a function for performing filing for the information saving portion 12, and a my menu button 24 for transferring to a basic screen that is customized by a user.

Then, when a new function is added, and the function is added, thereby needing to perform adjustment of the function, an adjustment button 25 is displayed on the start screen 20. This adjustment button is an example of the above-described transition button. It is assumed that the adjustment button 25 described below is not displayed in a state before a new function is added.

In the case of detecting that one or more new functions are added, it needs to perform setting corresponding to each function, however, the newly added functions are detected so that an adjustment item that is automatically settable is automatically set. For example, when a new toner is input, it is possible to bring a state where the toner is automatically replenished so as to be able to perform printing.

On the other hand, there is an adjustment item of a functional component that is not automatically settable. For example, a high-compression module or the like must be adjusted viewing a chart for adjustment placed since an adjustment value is changed according to a set value of an optical system. In the case of having such an adjustment item, the adjustment button 25 may be displayed, and an operator such as a service technician displays the adjustment screen with the adjustment button 25 to perform appropriate adjustment, then confirms the result and saves an adjustment value.

Note that, even in a state where the adjustment button 25 is displayed, in the image processing apparatus 1, it is possible to execute a function having no effect on an added function. For example, a high-compression module is related to filing or the like, however, has no effect on a copy function and a fax function (a part of which is however related), thus enabling use of the copy function even in a state where adjustment is not performed. Additionally, in a case where a large-capacity tray system or the like is mounted, print positioning is needed, however, even though adjustment is not performed, it is possible to use the fax function and a document filing function. Even in the case of a state where adjustment for a new function is not only needed but also is in execution, in a case where the copy function that is not related to the function is able to be used, the copy button 21 is pressed from a start screen to move to a basic screen of the copy function, and it is possible to execute copying. Similarly, in a case where the facsimile function is usable, the fax button 22 is pressed to move to a basic screen of the facsimile function, and it is possible to perform facsimile transmission.

Next, description will be given for a specific example of the adjustment screen with reference to FIG. 3. FIG. 3 is a diagram showing an example of the adjustment screen in the image processing apparatus of FIG. 1, in which an example of a screen is shown for transferring in a case where the adjustment button 25 is pressed.

On an adjustment screen 30 shown in FIG. 3, a list 32 for adjustment items concerning newly added functional components is displayed. In the list 32, a program number 32a indicating the adjustment item and a content 32b of the adjustment item corresponding thereto, and it is possible to move an adjustment item group that is currently displayed in the list 32 upward or downward with an up arrow key 34a or a down arrow key 34b. Moreover, on the adjustment screen 30, an entry field 31 is also provided for inputting any of the program number 32a, and a numerical keypad 33 is also displayed for such input.

Additionally, in the list 32 in FIG. 3, an example is provided that a program number is skipped, which is a result that in the case of pressing the adjustment button 25 from the start screen 20 of FIG. 2 to move, only the adjustment items concerning a new functional component, more preferably only the adjustment items required for adjustment concerning the new functional component are extracted to be displayed. Whether or not adjustment is needed may be decided in advance for each adjustment item of the functional component based on a standard for accurately functioning to some extent or the like so that whether or not adjustment is needed is stored. In this manner, on the adjustment screen 30, only a list of the adjustment items required for activating the functional component among the adjustment items concerning the functional component is preferably displayed. Since items required for adjustment of input of the adjustment value or the like are only displayed, an operator easily recognizes items to be executed, and is able to execute only a required adjustment item.

On such the adjustment screen 30, an operator may first input a program number of an adjustment item to be adjusted in the list 32 with the numerical keypad 33. In response to such input, the image processing apparatus 1 may display an individual adjustment screen corresponding to the program number to await input of the adjustment value. The operator executes adjustment viewing the individual adjustment screen.

In the case of finishing adjustment of a new function and leaving the adjustment screen 30 with a CLOSE button 35 or an EXIT button in the numerical keypad 33, the process returns to the start screen 20, in which the adjustment button 25 is no longer displayed. On the other hand, when the adjustment item of the new function is left, the adjustment button 25 is kept displayed.

In this manner, the adjustment button 25 is preferably displayed until a required adjustment item is set in order to activate a newly mounted functional component (that is, in order to utilize the above-described predetermined function concerning a new functional component). The adjustment button 25 is displayed on the start screen 20 until adjustment is performed so that an operator is able to make sure to finish various adjustments. Note that, description has been given for a processing example in which, in the case of adjustment in a restricted order, the transition button for the functional component required for first adjustment is displayed, and after the adjustment is finished, the transition button for the functional component required for next adjustment is displayed, however, such a processing example also corresponds to an example of displaying the button until a required adjustment item is set.

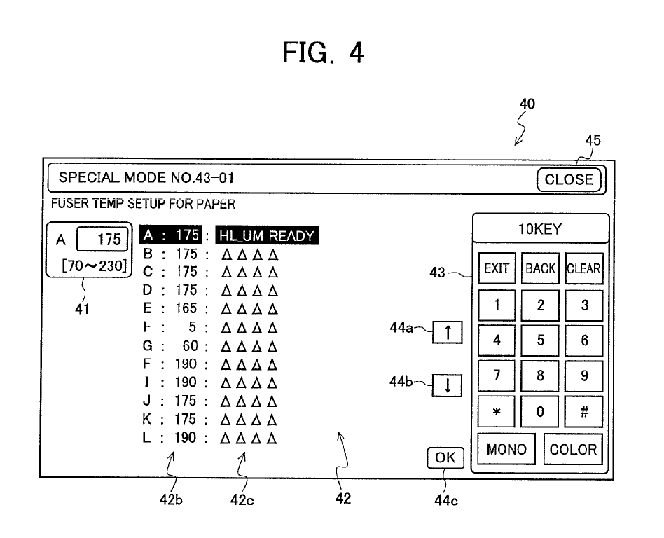

Further, the adjustment screen 30 is preferably the same as a screen accessible even by a special method only known to an operator such as a service technician. That is, the adjustment screen 30 is preferably configured to be displayable even in an operation procedure, in which the adjustment button 25 is not pressed from the start screen 20 (procedure in which one or more intermediate screens are processed). This makes it possible to save the effort of newly creating a UI image for the adjustment screen 30, and for a service technician to set by the same operation, which makes it possible to reduce mistakes and the like. Additionally, in examples of FIG. 3 and FIG. 4 described below, even in the case of shipping to a non-English speaking area, an English adjustment screen is consciously displayed, and this makes it possible to reduce a possibility that a common user is able to adjust even in the case of moving to such an adjustment screen.

Next, description will be given for a specific example of an individual adjustment screen with reference to FIG. 4. FIG. 4 is a diagram showing another example of the adjustment screen in the image processing apparatus of FIG. 1. FIG. 4 shows an example of a destination screen being moved in a case where a plurality of adjustment items are present, and a certain program number (in this example, No. 43-01) is input in the entry field 31 on the adjustment screen 30 of FIG. 3. Further, FIG. 4 is an example of a destination screen being moved in a case where there is only one adjustment item, and the adjustment button 25 is pressed on the start screen 20 of FIG. 2.

An individual adjustment screen 40 shown in FIG. 4 provides a screen example in a case where a temperature adjustment value of a fixing roller is an adjustment item. Such a temperature adjustment value is needed to be set scene by scene, and a set of such adjustment is completed as one adjustment. On the individual adjustment screen 40, temperature adjustment values A to L 42b are displayed by scene 42c as a list 42, one of which (in this example, temperature adjustment value A) is selected to be highlighted. Further, on the individual adjustment screen 40, an up arrow key 44a, a down arrow key 44b, an OK key 44c and a numerical keypad 43 are also displayed.

An operator may use the up arrow key 44a or the down arrow key 44b to move the temperature adjustment values to be input upward or downward to display an entry field 41 corresponding thereto, and use the numerical keypad 43 to input the temperature adjustment value concerning a scene being selected (in this example, scene corresponding to the temperature adjustment value A) in the entry field 41, then pressing an OK key 44c to be determined. Such work is performed for each scene, thereby finishing adjustment of a set of the temperature adjustment values. When adjustment is executed and the adjustment as work is finished, the control portion 10 of FIG. 1 saves a serial number and an adjustment item of the set target functional component in the information saving portion 12.

Input of the temperature adjustment value is also performed by a method of placing a color chart in the document reading portion 15 of FIG. 1 to be scanned, and performing automatic measurement of the adjustment value to be input, or an a method of printing the chart and reading the printed chart by a scanner to be automatically adjusted. In such a case, it is configured to display an instruction to place the chart on the individual adjustment screen 40, and display a result after performing automatic adjustment by pressing a start button of hardware that is provided outside a touch panel or the like to perform setting.

Further, in this manner, in the case of finishing adjustment of a new function and leaving the individual adjustment screen 40 with a CLOSE button 45 or an EXIT button in the numerical keypad 43, the process returns to the adjustment screen 30 or the start screen 20. In the case of employing list display, when an adjustment item required for adjustment is not left, the process may return to the start screen 20 in which the adjustment button 25 is not displayed, and when the adjustment item of the new function is left, the process may return to the adjustment screen 30 to exclude the item of which adjustment is finished from the list. In the case of not employing list display, when the adjustment item required for adjustment is not left, the process returns to the start screen 20 in which the adjustment button 25 is not displayed, and when the adjustment item of the new function is left, the process returns to the start screen 20 to keep the adjustment button 25 displayed. Also here, the adjustment button 25 is displayed until the adjustment item required for activating a newly mounted functional component is set.

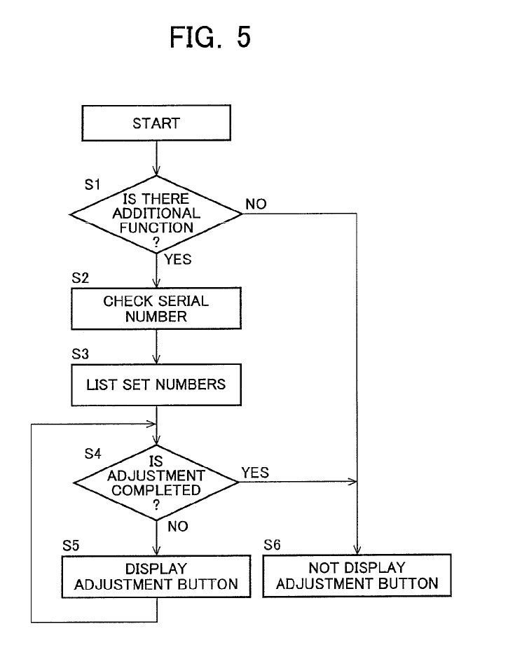

Next, with reference to FIG. 5, simple description will be given for a processing example at the time of starting including display control of the adjustment button. FIG. 5 is a flowchart for explaining an example of processing at the time of starting in the image processing apparatus of FIG. 1.

First, in the image processing apparatus 1, the function detection portion 13 checks at the time of starting whether or not a new option is added (step S1). In the case of NO at step S1, that is, in the case of no new additional function, the control portion 10 instructs the UI portion 11 to display a start screen without displaying the adjustment button (screen without the adjustment button 25 on the start screen 20 of FIG. 2) (step S6).

In the case of YES at step S1, that is, in the case of having a new additional function, in order to check a status of options, the function detection portion 13 obtains a serial number of the option from each additional module to be given to the information analysis portion 14 (step S2) since even though the same function is added, an option for which adjustment of replacement of the option or the like is unnecessary and not adjusted is mounted in some cases.

Subsequently, the information analysis portion 14 checks an adjustment item to be set (item of simulation) from a serial number of each option that is obtained at step S2 to be listed (step S3). Then, the control portion 10 obtains information on whether adjustment is finished from the number of each adjustment item to be set that is listed at step S3 (corresponding to the above-described program number) and a serial number from the information saving portion 12 to judge whether or not adjustment is finished (step S4).

In the case of NO at step S4, that is, in a case where there is a set item number for which adjustment is not completed from the information listed at step S3, as uncompleted setting, the control portion 10 instructs the UI portion 11 to display the adjustment button 25 on the start screen 20 as FIG. 2 (step S5). At the time, a search result at step S4 may be held because of being usable on the adjustment screen 30 of FIG. 3. On the other hand, in the case of YES at step S4, that is, in the case of completing all adjustment, the control portion 10 instructs the UI portion 11 not to display the adjustment button (step S6).

In order to allow such processing at step S4, when the adjusted functional component is removed, component information of a model number, a serial number or the like of the functional component may be stored so as to omit adjustment in the case of being mounted again. Thereby, the information analysis portion 14 judges at the time of starting when the adjusted functional component is mounted again, and it is possible to perform control such that the adjustment button is not displayed.

Here, the model number is stored so that it is possible to control not to perform display of the adjustment button even when the same functional component with a different serial number is mounted due to replacement in the event of failures or the like. On the other hand, the serial number is stored so that it is possible to control to display the adjustment button when the same functional component with a different serial number is mounted due to replacement in the event of failures or the like. Since there is a component required or not required for adjustment each time replacement is performed depending on a functional component, either one of the model number/serial number is stored according to necessity/unnecessity of adjustment to be referred at the time of starting so that it is possible to perform control corresponding thereto. Further, it is possible to perform the same control also by storing in advance whether or not adjustment is required together with the model number.

As described above, according to the present invention, it is possible to surely conduct a necessary adjustment for a functional component when the functional component is newly installed in an image processing apparatus which is able to equip a removable functional component providing a predetermined function.

1. An image processing apparatus which is able to equip a removable functional component providing a predetermined function and is provided with a touch panel as an operation panel, wherein
when the image processing apparatus is started in a state where the functional component is newly mounted, a transition button is displayed on a start screen displayed on the operation panel for transferring to an adjustment screen for performing adjustment concerning the functional component, and when the transition button is pressed, the adjustment screen is displayed.

2. The image processing apparatus as defined in claim 1, wherein
the transition button is displayed until an adjustment item required for activating the functional component is set.

3. The image processing apparatus as defined in claim 1, wherein
on the adjustment screen, only a list of adjustment items required for activating the functional component among adjustment items concerning the functional component is displayed.

4. The image processing apparatus as defined in claim 1, wherein
the adjustment screen is configured to be displayable even in an operation procedure in which the transition button is not pressed from the start screen.
